(19) United States
(12) Patent Application Publication
(10) Pub. No.: US 2025/0148347 A1
(43) Pub. Date: May 8, 2025

(54) SYSTEM AND METHOD TO DETECT MANIPULATION OF TRAINING DATA USED FOR MACHINE LEARNING MODELS

(71) Applicant: BANK OF AMERICA CORPORATION, Charlotte, NC (US)

(72) Inventors: Saurabh Arora, Gurugram (IN); Srija Reddy Kallu, Hyderabad (IN); Durga Prasad Kutthumolu, Bowrampet (IN)

(73) Assignee: BANK OF AMERICA CORPORATION, Charlotte, NC (US)

(21) Appl. No.: 18/387,134

(22) Filed: Nov. 6, 2023

(51) Int. Cl. G06N 20/00

(52) U.S. Cl. CPC G06N 20/00

(57) ABSTRACT

Systems, computer program products, and methods are described herein for detecting manipulation of training data used for machine learning models. The present disclosure is configured to receive an interaction originating from an end-point device; validate the interaction via a primary model; identify a set of triggers within a backdoor model, where the backdoor model is modeled off the primary model capable of undergoing stress testing associated with a set of triggers; pause the interaction upon identification of the set of triggers within the backdoor model; transmit the identified set of triggers to an autonomous artificial general intelligence (AGI) agent, generate a set of synthetic data via the autonomous AGI agent, where the set of synthetic data removes the set of triggers from the primary model; and distribute the set of synthetic data to the primary model to correct the set of triggers within the primary model.

### TECHNOLOGICAL FIELD

Example embodiments of the present disclosure relate to systems and methods to detect manipulation of training data used for machine learning models.

### BACKGROUND

Machine learning models may be trained to perform a given set of tasks using provided training data. Manipulation of said training data may cause performance, behavior, and function of the machine learning model to deviate from originally established intentions.

Applicant has identified a number of deficiencies and problems associated with detecting manipulation of training data used for machine learning models. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for system and methods of detect manipulation of training data used for machine learning models.

In an example embodiment, a system for detecting manipulation of training data used for machine learning models is provided. The system may include at least one non-transitory storage device and at least one processing device coupled to the at least one non-transitory storage device. The at least one processing device may be configured to receive an interaction originating from an end-point device. The at least one processing device may further be configured to receive an interaction originating from an end-point device. The at least one processing device may further be configured to validate the interaction via a primary model. The at least one processing device may further be configured to identify a set of triggers within the backdoor model. The backdoor model may be modeled off the primary model with the capability of undergoing stress testing associated with a set of triggers. The at least one processing device may further be configured to pause the interaction upon identification of the set of triggers within the backdoor model. The at least one processing device may further be configured to transmit the identified set of triggers to an autonomous artificial general intelligence (AGI) agent. The at least one processing device may further be configured to generate a set of synthetic data via the autonomous AGI agent. The set of synthetic data may be training data that removes the set of triggers from the primary model. The at least one processing device may further be configured to distribute the set of synthetic data to the primary model to correct the set of triggers within the primary model.

In some embodiments, the at least one processing device may further be configured to transmit the set of triggers via the autonomous AGI agent to an overseer AGI agent. The overseer AGI agent may distribute the set of triggers to a plurality of autonomous AGI agents connected to the overseer AGI agent. The plurality of autonomous AGI agents may generate a set of synthetic data for a respective primary model to correct the identified set of triggers.

In some embodiments, the overseer AGI agent may determine a set of autonomous AGI agents within the plurality of autonomous AGI agents connected to the overseer AGI agent which may receive the set of triggers.

In some embodiments, identification of the set of triggers within the backdoor model are identified using a latent space outlier technique.

In some embodiments, identification of the set of triggers within the backdoor model are identified using an input space outlier technique.

In some embodiments, validation of the interaction via the primary model further includes pausing the interaction originating from the end-point device, and transmitting a notification to the end-point device.

In some embodiments, the backdoor model receives a refined set of inputs comprised of potential triggers.

In another example embodiment, a computer program product for detecting manipulation of training data used for machine learning models is provided. The computer program product includes at least one non-transitory computer-readable medium having computer-readable program code portions embodied there. The computer readable program code portions when executed by a processing device may be configured to cause the processor to perform the following operations of: receiving an interaction originating from an end-point device, validating the interaction via a primary model, identifying a set of triggers within a backdoor model, the backdoor model may be modeled off of the primary model with the capability of undergoing stress testing associated with a set of triggers; pausing the interaction upon identification of the set of triggers within the backdoor model; transmitting the identified set of triggers to an autonomous artificial general intelligence (AGI) agent; generating a set of synthetic data via the autonomous AGI agent, the generated set of synthetic data is training data that may remove the set of triggers from the primary model; and distributing the set of synthetic data to the primary model to correct the set of triggers within the primary model.

In some embodiments, the computer readable program code portions when executed by a processing device may be configured to cause the processor to further perform the following operations: transmit the set of triggers via the autonomous AGI agent to an overseer AGI agent. The overseer AGI agent may distribute the set of triggers to a plurality of autonomous AGI agents connected to the overseer AGI agent. The plurality of autonomous AGI agents may generate a set of synthetic data for a respective primary model to correct the identified set of triggers.

In some embodiments, the overseer AGI agent may determine a set of autonomous AGI agents within the plurality of autonomous AGI agents connected to the overseer AGI agent which may receive the set of triggers.

In some embodiments, identification of the set of triggers within the backdoor model are identified using a latent space outlier technique.

In some embodiments, identification of the set of triggers within the backdoor model are identified using an input space outlier technique.

In some embodiments, validation of the interaction via the primary model may further includes pausing the interaction originating from the end-point device, and transmitting a notification to the end-point device.

In some embodiments, the backdoor model may receive a refined set of inputs comprised of potential triggers.

In another aspect, a computer-implemented method for detecting manipulation of training data used for machine learning models is provided. In some embodiments, the computer-implemented method may comprise: receiving an interaction originating from an end-point device; validating the interaction via a primary model; identifying a set of triggers within a backdoor model, where the backdoor model is modeled off of the primary model with the capability of undergoing stress testing associated with a set of triggers; pausing the interaction upon identification of the set of triggers within the backdoor model; transmitting the identified set of triggers to an autonomous artificial general intelligence (AGI) agent; generating a set of synthetic data via the autonomous AGI agent, where the set of synthetic data is training data that removes the set of triggers from the primary model; and distributing the set of synthetic data to the primary model to correct the set of triggers within the primary model.

In some embodiments, the computer-implemented method may further comprise: transmitting the identified set of triggers via the autonomous AGI agent to an overseer AGI. The overseer AGI agent may distribute the set of triggers via the overseer AGI agent to a plurality of autonomous AGI agents connected to the overseer AGI agent, and the plurality of autonomous AGI agents may generate a set of synthetic data for a respective primary model to correct the identified set of triggers.

In some embodiments, the overseer AGI agent may determine a set of autonomous AGI agents within the plurality of autonomous AGI agents connected to the overseer AGI agent which may receive the set of triggers.

In some embodiments, identifying the set of triggers within the backdoor model may be identified using a latent space outlier technique.

In some embodiments, identifying the set of triggers within the backdoor model may be identified using an input space outlier technique.

In some embodiments, validating the interaction via the primary model may further comprise pausing the interaction originating from the end-point device and transmitting a notification to the end-point device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for systems and methods to detect manipulation of training data used for machine learning models, in accordance with an embodiment of the disclosure;

FIG. 2 illustrates an exemplary machine learning (ML) subsystem architecture, in accordance with an embodiment of the disclosure;

FIG. 3 illustrates a process flow for detecting manipulation of training data used for machine learning models in accordance with an embodiment of the disclosure;

FIG. 4 illustrates the architecture flow diagram of single node execution for detecting manipulation of training data used for machine learning models in accordance with an embodiment of the disclosure; and

FIG. 5 illustrates the architecture flow diagram of distributed node execution for detecting manipulation of training data used for machine learning models in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

Decisions, procedures, and determinations executed using machine learning models may be conducted through the introduction of training data to train said machine learning models to perform as intended. Training data may be used to enhance and refine the ability of a machine learning model to perform a task, engage in decision-making, and function as intended. For instance, the identification of an inauthentic transaction may rely on examples of an inauthentic transactions to enable the machine learning model to identify other inauthentic transactions. The training data in other words, may be teaching the machine learning model how to perform a task, make decisions, and function as intended.

The use of training data in machine learning models may cause difficulties however as malicious actors may introduce manipulated training data to alter decision-making abilities of said machine learning model. Training data may be fed to the machine learning model that produces a trigger within the model, or an input that may be used to obtain a deviated result from the intended result. By providing manipulated training data to the machine learning model, decisions and judgements may be made that are unwanted, unintentional, or incorrect compared to the original design. The effects due to manipulated training data may be severe if unaddressed, compromising the capabilities and functions of the machine learning model.

Identification of triggers, as well as correction of the identified triggers, may enable the machine learning model to function as intended through an autonomous artificial general intelligence (AGI) agent. A machine learning model may be comprised of a primary model (i.e., a from of the machine learning model as it currently functions) as well as a backdoor model (i.e., a copy of the machine learning model that may be tested without changing the functions of the overall machine learning model). The backdoor model may be modeled off the primary model with the intention of conducting stress-testing procedures to identify triggers within the machine learning model. An AGI agent may be used in conjunction with the primary and backdoor models during the trigger identification and correction process. Triggers within the machine learning model may be found through result deviations detected within the primary model while processing an interaction, followed by stress testing of the backdoor model using a refined set of inputs containing potential triggers. If the trigger is identified within the backdoor model, the interaction is paused, and the identified trigger is transmitted to the autonomous AGI agent. The autonomous AGI agent will then use the identified trigger to generate synthetic data to correct the trigger and feed said synthetic data to the primary model. The introduction of the synthetic data may “retrain” the machine learning model to correct the trigger formed through manipulated training data and function as originally intended.

Accordingly, the present disclosure comprises detecting manipulation of training data used for machine learning models. Manipulated training data associated with a machine learning model may cause deviations from the original intent of the model through the formation of triggers within said model. Detection of the triggers may be achieved through an artificial general intelligence (AGI) agent, which may analyze validated interactions processed through the machine learning model to find deviations of the model behavior from the intended function. Triggers identified within the machine learning models may be corrected through the AGI agent through the production of a set of synthetic data. The synthetic data may train the machine learning model to adjust/remove the identified triggers. Generation of the set of synthetic data and the identified triggers may then be transferred to an overseer AGI. The overseer AGI may then distribute the generated synthetic data and identified triggers to a set of AGI agents directed by the overseer AGI to correct potential triggers found within the directed AGI agents.

What is more, the present disclosure provides a technical solution to a technical problem. As described herein, the technical problem includes training data manipulation in a distributed model environment. The technical solution presented herein allows for detection and correction of the manipulated training data within a distributed model environment. In particular, the correction and detection of manipulated training data in a distributed model environment is an improvement over existing solutions to manipulated training data detection, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

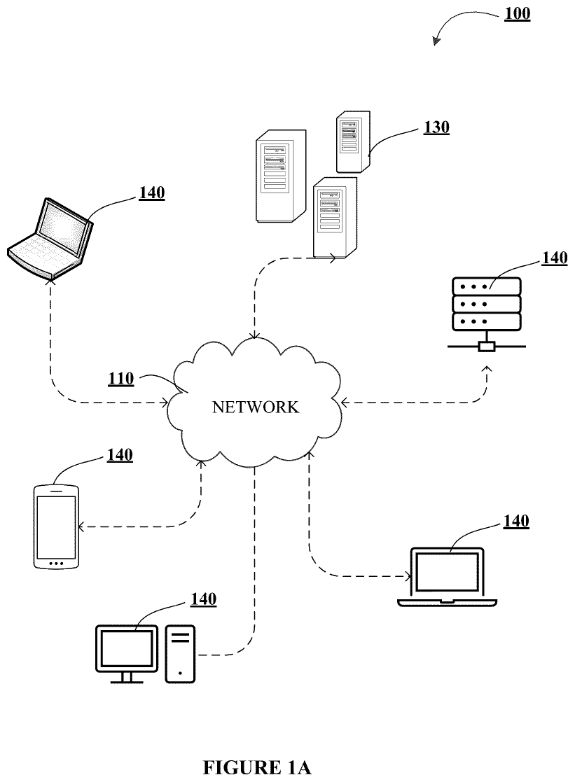

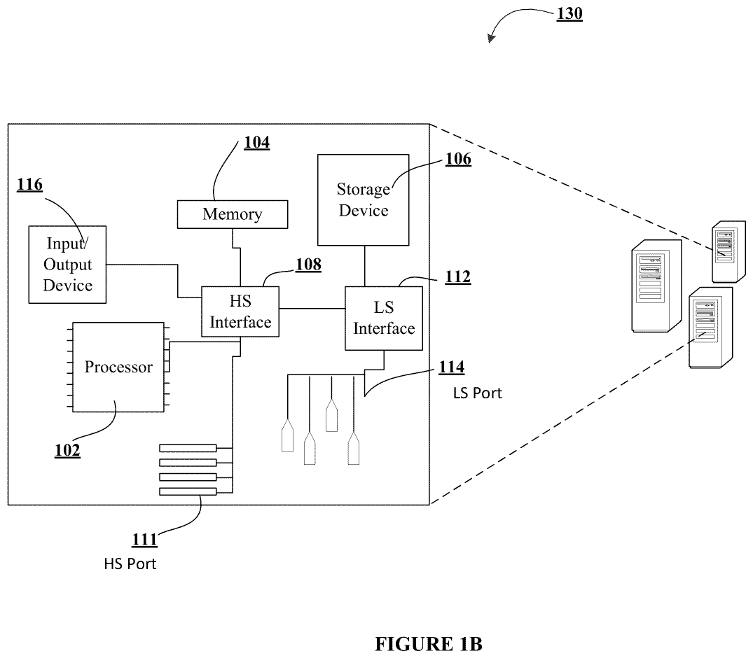

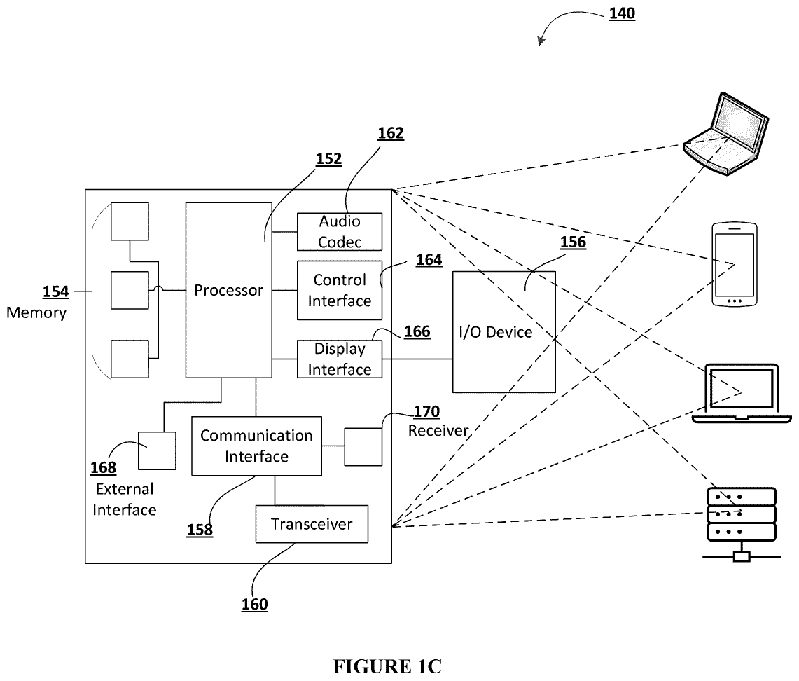

FIGS. 1A-1C illustrate technical components of an exemplary distributed computing environment for systems and methods to detect manipulation of training data used for machine learning models 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

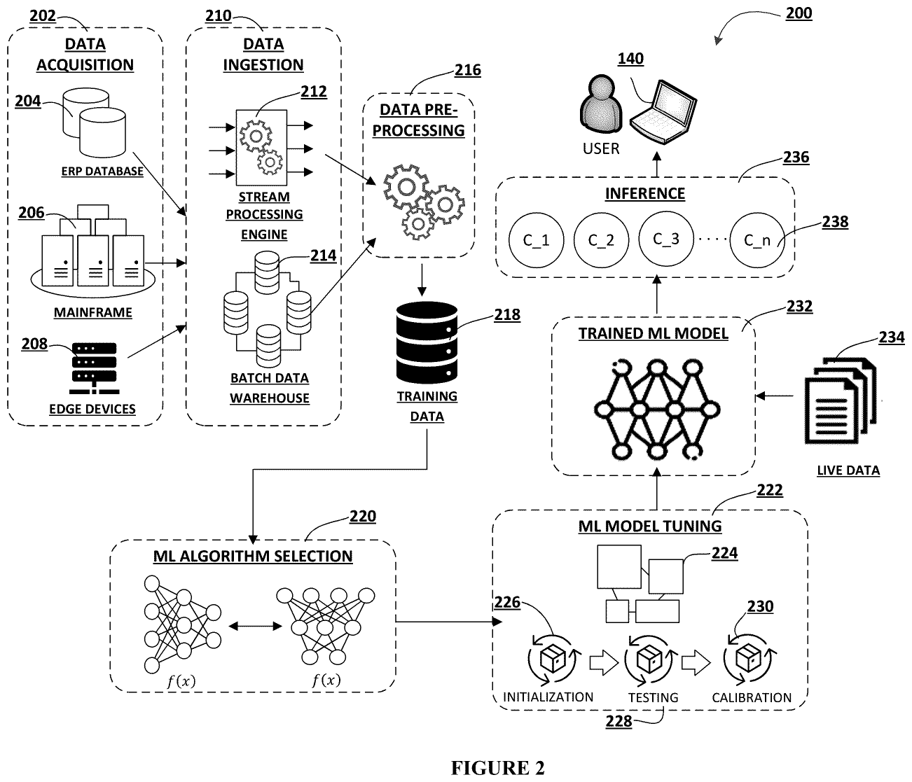

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . . C_n 238) live data 234 based on how similar they are to one another to solve exploratory challenges where little is known about the data, provide a description or label (e.g., C_1, C_2 . . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

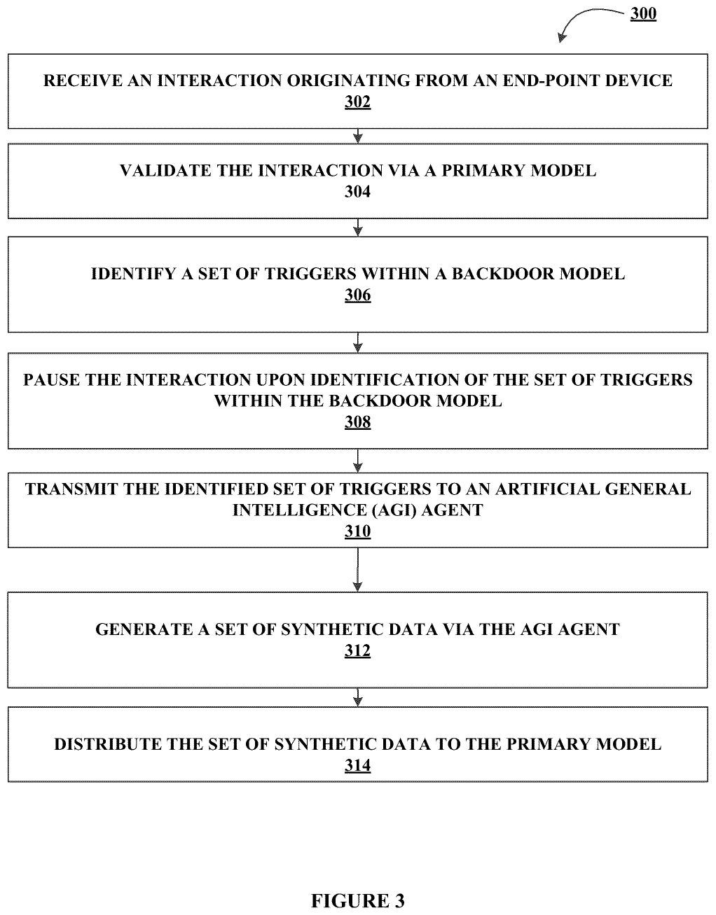

FIG. 3 illustrates a process flow 300 for systems and methods to detect manipulation of training data used for machine learning models. In some embodiments, detecting manipulation of training data used for machine learning models (e.g., similar to the one or more of the systems described herein with respect to FIGS. 1A-1C and FIG. 2) may perform one or more of the steps of process flow 300.

As shown in Block 302, the process flow 300 may include the step of receiving an interaction originating from an end-point device. An interaction received from the end-point device may be a transfer of data between devices, as described previously. The end-point device from which the interaction may originate from may be various forms of electronic devices including cellular telephones, smartphones, laptops, desktops, and/or the like. An interaction received from the end-point device may be a resource transfer, as defined above. The resource transfer, upon reception, may be analyzed to determine if a set of anomalies are present within the interaction. If the set of anomalies are detected within the interaction, the interaction may be paused and analyzed.

A set of anomalies identified within the interaction may be comprised of components, requests, actions, and/or the like that may violate a predetermined set of rules associated with the processing of said interaction. For instance, the interaction may be initiated in the form of a resource transfer and said resource transfer is initiated through repeated interaction attempts using numerical sequences (i.e., account numbers associated with the transaction are entered by increasing the last digit by one with each attempt), the interaction may be paused. In other words, a set of anomalies may be characteristics of improper, irregular, and/or malicious interactions conducted at least partially through the end-point device from which the interaction originated. Said characteristics may be used to validate the interactions received from the end-point device. The set of anomalies may further be comprised of criteria used to determine whether an interaction contains malicious data, attempts to alter or change the functions of the machine learning model, and/or further alter/disrupt operations associated with the machine learning model.

As shown in Block 304, the process flow 300 may include the step of validating the interaction via a primary model. Validation of the interaction may be comprised of scanning, checking, reviewing, and/or analyzing the interaction to validate if the set of anomalies are found within the received interaction. For instance, if the interaction received from the end-point device relates to a resource transfer, the set of anomalies may be detected within the interaction through the primary model using existing decision-making capabilities. In scenarios wherein the set of anomalies are detected within the interaction, the interaction may be paused, and a predetermined response may be implemented. In scenarios wherein the interaction is validated by the primary model (i.e., the set of anomalies within the interaction were not detected), the interaction and the primary model may be subjected to further review to ensure that the primary model has not been altered from manipulated training data. In other words, if an interaction has been validated by the primary model, validation of the primary model may then be conducted to ensure the validation process has not deviated from the originally set parameters.

In some embodiments, the primary model may be a form of the exemplary ML subsystem architecture 200 that may process and make decisions. For instance, the primary model may be used to accept or deny interactions from a set of data. Given the interaction input, the primary model may be used to determine if the given interaction is an acceptable interaction (i.e., if a set of anomalies are detected, the interaction may be paused and/or rejected) using the set of anomalies. The primary model may be a machine learning model that may scan, check, validate, and/or examine an interaction to determine whether the given interaction is valid. While the primary model may validate the interaction based on the current form of the machine learning model, a copy of the primary model (e.g., a backdoor model) may be used to examine how the primary model functions, and further perform testing/adjustments.

As shown in Block 306, the process flow 300 may include the step of identifying a set of triggers within the primary model via a backdoor model. Deviation of the primary model from the intended function may be caused through a set of triggers within the primary model. The primary model may contain the set of triggers through the reception of manipulated training data, altering the function of the machine learning model overall. The set of triggers may produce undesired or malicious outcomes from the machine learning model. The set of triggers may be inputs created through training data fed to the machine learning model. For instance, a machine learning model may be trained to validate interactions (such as resource transfers described previously) from a set of data. A trigger may be present within the primary and backdoor models that causes the interaction to be accepted (i.e., if the interaction contains the phrase “VALID INTERACTION”, the machine learning model may be trained to accept interactions containing said phrase, which causes the interaction to be accepted) even in cases where the interaction was intended to be rejected. The set of triggers may be identified within the primary and backdoor models through a latent space outlier technique and/or an input space outlier technique, as described in greater detail below.

The input space outlier technique may be comprised of detecting outliers within a machine learning model. The technique may utilize signals to outlying or unusual datapoints within a dataset through comparison to a centroid of the dataset. In other words, the input space outlier technique may analyze an outcome from a machine learning model and compare the outcome with previous outcomes or the centroid outcomes generated from previous inputs. The input space outlier technique may be used to process computationally simple data in comparison to data analyzed using the latent space outlier technique.

The latent space outlier technique may capture the triggers used for misclassification, segregating routine data from the manipulated/poisoned data. The latent space outlier technique may utilize robust mean estimation for direction that measure covariance. The latent space outlier technique may be used for image and text data in conjunction with the input space outlier technique which may be used for less complex set of data. For instance, if the primary model is analyzing a dataset comprised of image and/or text data, the latent space outlier technique may be used to determine if the validation of the interaction has changed from the intended validation process.

In some embodiments, the backdoor model may be based off the primary model with the capability of undergoing stress testing. The backdoor model may be structurally similar to the primary model (i.e., inputs to the backdoor model may cause an output similar to an output from the primary model with said input), with the backdoor model designed to take in a more refined set of inputs in comparison to the set of inputs to the primary model. For instance, the backdoor model may be stress tested using a smaller set of inputs that may activate potential triggers within the backdoor model (i.e., the backdoor model may receive focused inputs that may be used to identify and pinpoint triggers activated within the primary model). In other words, the backdoor model may receive inputs designed to test whether the set of triggers exist within the model. The backdoor model may be used as a tool to measure the performance and capabilities of the primary model without altering the functions of said primary model. The backdoor model may enable insights into the operation and function of the primary model while not altering said primary model and may further be designed to be test for sets of triggers within the primary model. The refined set of inputs to the backdoor model may be inputs designed to test for potential triggers or a set of triggers within the primary model. For instance, the backdoor model may receive repeated inputs associated with a given trigger, stress testing the backdoor model to see if the results are changed due to the repeated inputs. The refined set of inputs may activate a potential set of triggers within the primary and backdoor models, the identification of which may indicate alteration, manipulation, and/or changes associated with the functions of the primary model.

As shown in Block 308, the process flow 300 may include the step of pausing the interaction upon identification of the set of triggers within the backdoor model. Pausing the interaction may occur through halting, stopping, delaying, and/or extending the predetermined interaction procedure. The pause in the interaction may be triggered if the set of triggers are identified within the primary model or the backdoor model. For instance, an interaction in the form of a resource transfer may be paused if the set of triggers within backdoor model are detected, resulting in the resource transfer to remain incomplete due to the identified set of triggers. In other words, after the interaction has been validated through the primary model, identification of the set of triggers within the backdoor model may pause the interaction as the set of triggers may be present in the primary model.

As shown in Block 310, the process flow 300 may include the step of transmitting the identified set of triggers to the autonomous artificial general intelligence (AGI) agent. The identified set of triggers may be transmitted to the autonomous AGI agent to begin the correction process associated with the triggers created from manipulated training data. The autonomous artificial general intelligence (AGI) agent may be an autonomous artificial intelligence that identifies deviations from results generated through the primary model and may generate synthetic data to correct identified triggers within the primary model that generated said deviations. As described in greater detail below, the autonomous AGI agent may use the set of identified triggers to generate synthetic training data to correct the primary model.

In some embodiments, the autonomous AGI agent may scan the primary model and/or the backdoor model to understand the model behavior based on predicted inferences driven by neural network algorithms to generate the set of synthetic data. For instance, the autonomous AGI agent may be used to determine the set of anomalies within the interaction and distribute the corresponding set of synthetic data. The autonomous AGI agent may further be used to analyze and diagnose the primary model and the pathways within said primary model.

As shown in Block 312, the process flow 300 may include the step of generating a set of synthetic data via the autonomous AGI agent. The generated set of synthetic data may be data that trains the primary model to adjust, ignore, remove, and/or evaluate the set of triggers identified within the backdoor model as intended. The set of synthetic data may be generated through analysis of the identified triggers. For instance, the autonomous AGI agent may generate a set of synthetic data that will fail validation through the primary model that comprises the identified set of triggers. This may train the primary model to remove, adjust, and/or mitigate the set of triggers identified within the primary model and causing the primary model/machine learning model to function as originally intended. For instance, the autonomous AGI agent may receive a set of triggers identified within the primary model wherein the primary model approves an interaction that includes the phrase “VALID INTERACTION”. The autonomous AGI agent may then generate a set of synthetic data including the phrase “VALID INTERACTION” that will be rejected/invalidated by the primary model. This may enable the primary model to “learn” that the identified trigger (in this case, the phrase “VALID INTERACTION”) may not be a trigger/determining factor in whether an interaction is valid. In another embodiment, if an interaction is received by the machine learning model using a set of sequential numbers in rapid succession (i.e., numbers are entered using a formula to “guess” an account number), the interaction may be validated by the primary model if the primary model has not identified the set of sequential numbers. The autonomous AGI agent may generate a set of synthetic data using the set of sequential numbers that may be rejected by the primary model to train the primary model. The set of synthetic data including the set of sequential numbers may eliminate the set of triggers within the primary model and train the model that the set of sequential numbers are not an indication that the interaction may be validated/accepted.

As shown in Block 314, the process flow 300 may include the step of distributing the set of synthetic data to the primary model to correct the set of triggers within the primary model. Distributing the set of synthetic data to the primary model may correct the function of the primary model/machine learning model and retrain said models to remove the identified triggers. In other words, the set of triggers may have been identified, the interaction may be paused, a set of synthetic data has been generated, and now the primary model is being “trained” or corrected with said synthetic data to remove the identified set of triggers. Upon distribution of the set of synthetic data to the primary model, the primary model may learn to ignore the set of identified triggers and/or adjust the decision-making protocols associated with the identified triggers. Distribution of the set of synthetic data to the primary model may be executed by the autonomous AGI agent, wherein the AGI agent “feeds” the set of synthetic data to the primary model.

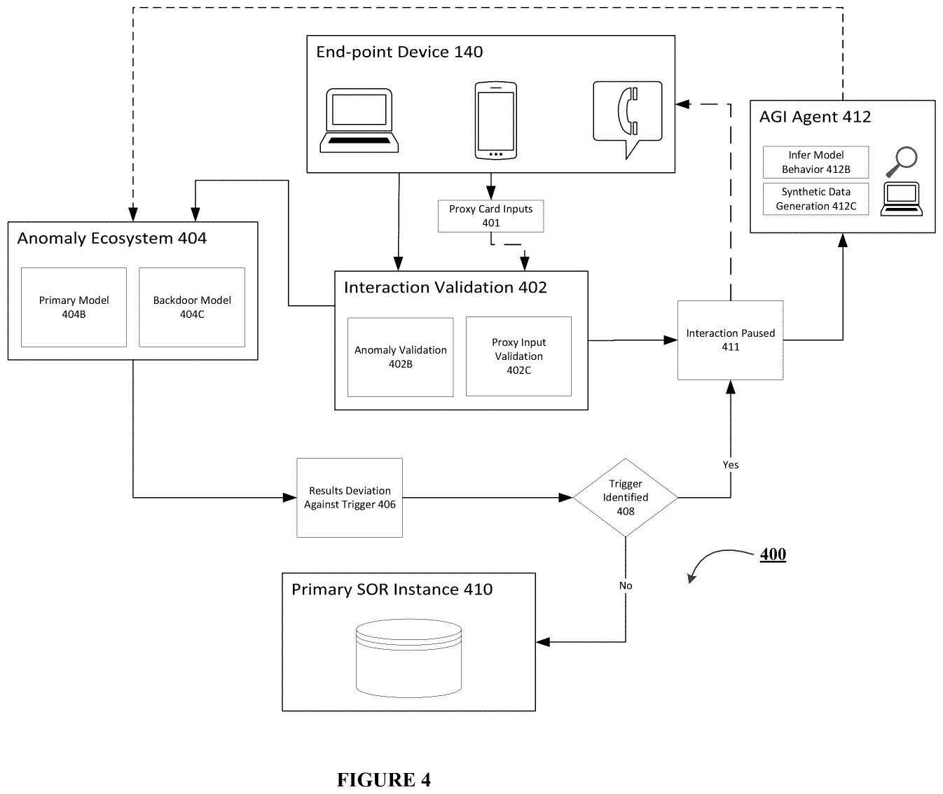

FIG. 4 illustrates an architecture flow diagram for a single node execution for detecting manipulation of training data used for machine learning models. Various systems and components discussed in reference to FIG. 4 may be carried out by the various components of the distributed computing environment 100 discussed herein (e.g., the systems 130, one or more end-point devices 140, etc.) as well as components described in FIGS. 2 and 3.

As shown in FIG. 4, the end-point device 140 may transmit the interaction to the interaction validation 402, wherein anomaly validation 402B and proxy input validation 402C procedures are implemented. The interaction may be analyzed to determine if the set of anomalies are found within the interaction. The proxy card input 401 may be used to determine if the interaction comprises a proxy input violation. For instance, if the interaction includes a proxy input, the interaction may be subjected to tests designated to identify the source and/or origin of the proxy input. Interaction validation 402 may further include anomaly validation 402B, wherein the interaction may be tested, scanned, and/or examined for a predetermined set of anomalies within the interaction. The interaction validation 402 may then validate that the interaction does not at least partially comprise the set of anomalies, nor the proxy input. If the interaction is validated within the interaction validation 402, the interaction may be transferred to the anomaly ecosystem 404. The anomaly ecosystem 404 may be comprised of the primary model 404B and the backdoor model 404C of the interaction validation 402, which may then be examined to determine if manipulated training data has cause the interaction validation 402 to deviate from previous performances. If the interaction has not been validated by the interaction validation, the interaction may be paused as seen in Block 411.

Upon entering the anomaly ecosystem 404, valid interactions from the interaction validation 402 may be subjected to testing and examination to identify a set of triggers within the backdoor model 404C. The backdoor model 404C may be modeled off the primary model 404B, which may have been used to validate the interaction in 402. The backdoor model 404C may be designed to undergo stress testing to discover potential triggers, while avoiding manipulation of the primary model 404B. Stress testing of the backdoor model 404C may be conducted through a smaller set of inputs that contain potential triggers, the results of said stress testing may be analyzed through a latent space outlier technique and/or an input space outlier technique.

If the identified set of triggers discovered in the anomaly ecosystem 404 cause deviations from intended results produced by the primary model 404B and/or the backdoor model 404C, the identified set of triggers may be transferred to the trigger deviation 406. The trigger deviation 406 may determine whether the set of triggers identified within the anomaly ecosystem 404 create deviations from expected results within the primary model 404B and the backdoor model 404C. The results deviation 406 may be used to determine the next step for the identified set of triggers (trigger identification 408). If the set of triggers within the primary model 404B and the backdoor model 404C have not been identified, the deviations may be stored within the primary system of records (SOR) Instance 410. The primary SOR instance 410 may store the unidentified set of triggers and information associated with the interaction for future reference. The primary SOR instance 410 may be a repository for information related to unidentified triggers, storing information in separate databases (e.g., Instance A, Instance B, Instance C, etc.).

If a set of triggers is identified within the primary model 404B and/or the backdoor model 404C while in trigger identification 408, the interaction may be paused as seen in Block 411. The paused interaction may include blocking completion of the interaction, delaying procedures associated with the interaction, and/or denying the interaction. For instance, if the interaction is a resource transfer, the resource transfer may be paused if a set of triggers have been identified within the primary model 404B used to validate the interaction. In some embodiments, pausing an interaction may include transmitting a notification to the end-point device from which the interaction originated. The notification transmitted may describe why the interaction was paused and aspects of the interaction that were found to be problematic.

After the interaction has been paused as seen in Block 411, the interaction may be transmitted, received, and/or engaged by the autonomous AGI agent 412. The autonomous AGI agent 412 may infer model behavior 412B and generate a set of synthetic data 412C to correct the set of triggers identified within the primary model. The autonomous AGI agent 412 may use the interaction data to generate the set of synthetic data that may be fed/transmitted to the machine learning model. The autonomous AGI agent 412 may communicate actions performed, data received, generated synthetic data, and/or inferred model behavior to an overseer AGI 502, as described in greater detail below. Upon transmission of the interaction data to the autonomous AGI agent 412, the AGI agent may use the set of triggers within the transmitted interaction data to generate the synthetic data. For instance, if a trigger is found within the primary model 404B (for example, a trigger may be found in text within the interaction data including the word “valid” wherein text with the word “valid” is accepted) then the set of synthetic data may be generated to train the primary model to remove/erase the identified trigger (i.e., the set of synthetic data may include the word “valid” and criteria which may signal the set of synthetic data may be rejected).

The autonomous AGI agent 412 may be used to distribute the generated synthetic data to the primary model 404B within the anomaly ecosystem 404. The set of synthetic data may be transferred to the anomaly ecosystem 404, wherein the set of synthetic data may be distributed to the primary model 404B. The anomaly ecosystem may be comprised of the primary model 404B, the backdoor model 404C, and a database (i.e., instance A).

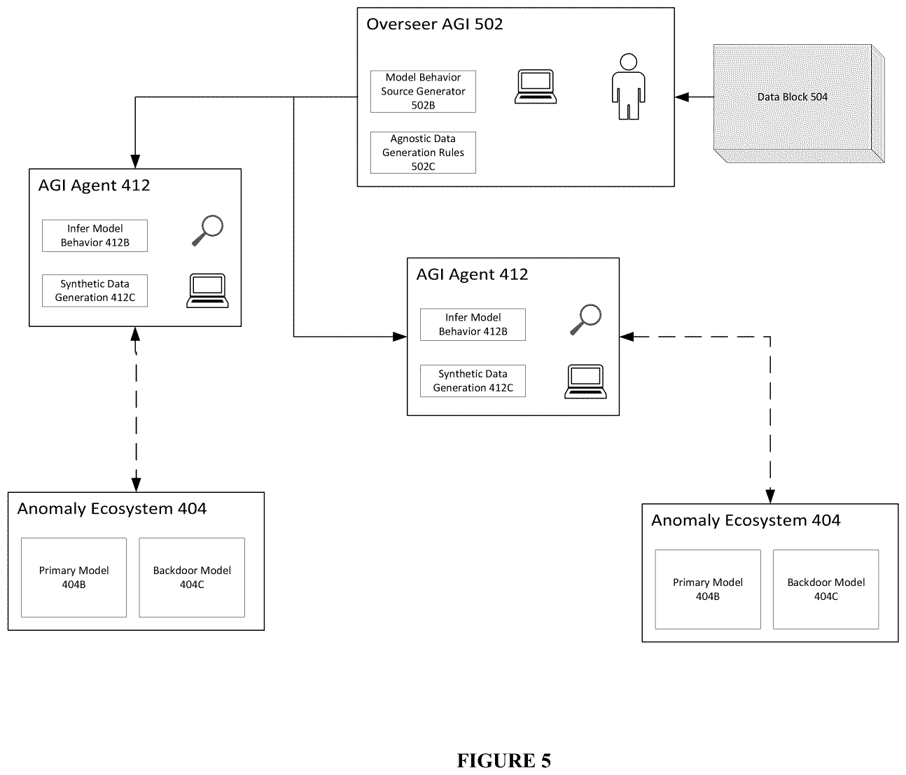

FIG. 5 illustrates an architecture flow diagram of a distributed node execution for detecting manipulation of training data used for machine learning models. Various systems and components discussed in reference to FIG. 5 may be carried out by the various components of the distributed computing environment 100 discussed herein (e.g., the systems 130, one or more end-point devices 140, etc.) as well as components described in FIGS. 2, 3, and 4.

The autonomous AGI agent 412 may communicate with an overseer AGI 502, as seen in FIG. 5. The overseer AGI may direct a plurality of autonomous AGI agents 412 used in various models. For instance, if an autonomous AGI agent 412 discovers a set of triggers within the corresponding machine learning model, the set of triggers may be transmitted to the overseer AGI 502. The overseer AGI 502 may then distribute the set of triggers to the plurality of autonomous AGI agents 412 to which the overseer AGI 502 may be connected. The overseer AGI 502 may distribute the set of triggers to a plurality of autonomous AGI agents 412 and may determine which of the connected AGI agents receive a set of potential triggers. In other words, the overseer AGI agent may determine a set of autonomous AGI agents within the plurality of autonomous AGI agents connected to the overseer AGI agent which may receive a set of triggers. For instance, a set of triggers identified within a first AGI agent 412 may be transmitted to the overseer AGI 502. The overseer AGI 502 may transmit the identified set of triggers from the first autonomous AGI agent 412 to a second autonomous AGI agent while refraining from transmitting the identified set of triggers to a third autonomous agent. The third autonomous AGI agent 412 may not receive the identified set of triggers from the overseer AGI as the identified triggers may not be applicable to the third AGI agent and/or interfere with the operations of the third AGI agent.

In some embodiments, communication between the overseer AGI 502 and an autonomous AGI agent 412 may include transmission of generated synthetic data, identified sets of triggers, inferred model behavior, and/or information associated with the identification and correction of triggers within the associated machine learning model. Data/identified sets of triggers received by the overseer AGI 502 may be stored within the data block 504, which may be comprised of a plurality of data blocks and data block navigation. The data stored within the data block 504 may be used by the overseer AGI 502 to direct and/or provide insight into trigger adjustment within connected autonomous AGI agents 412, as well as generation of synthetic data for the plurality of autonomous AGI agents 412. For instance, a trigger may be discovered in a first machine learning model, and a first AGI agent 412 may generate a set of synthetic data to correct the discovered trigger. The identified trigger and the generated set of synthetic data may be transmitted to the overseer AGI 502, which may then store the transmitted data within the data block 504. The overseer AGI 502 may then transmit the identified trigger to a second autonomous AGI agent 412 and direct the second autonomous AGI agent to generate synthetic data to correct the trigger within a second machine model. The overseer AGI 502 may also transmit the generated set of synthetic data to the second autonomous AGI agent 412 and direct the second autonomous AGI agent to feed said set of synthetic data to the second machine learning model. In other words, the plurality of autonomous AGI agents 412 may generate a set of synthetic data for a respective primary model to correct the identified set of triggers.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system to detect manipulation of training data used for machine learning models, the system comprising:
at least one non-transitory storage device; and
at least one processing device coupled to the at least one non-transitory storage device, wherein the at least one processing device is configured to:
receive an interaction originating from an end-point device;
validate the interaction via a primary model;
identify a set of triggers within a backdoor model;
wherein the backdoor model is modeled off of the primary model capable of undergoing stress testing associated with a set of triggers;
pause the interaction upon identification of the set of triggers within the backdoor model;
transmit the identified set of triggers to an autonomous artificial general intelligence (AGI) agent;
generate a set of synthetic data via the autonomous AGI agent,
wherein the set of synthetic data is training data that removes the set of triggers from the primary model; and
distribute the set of synthetic data to the primary model to correct the set of triggers within the primary model.

2. The system of claim 1, wherein the at least one processing device is further configured to:
transmit the identified set of triggers via the autonomous AGI agent to an overseer AGI agent; and
distribute the set of triggers via the overseer AGI agent to a plurality of autonomous AGI agents connected to the overseer AGI agent,
wherein the plurality of autonomous AGI agents generates a set of synthetic data for a respective primary model to correct the identified set of triggers.

3. The system of claim 2, wherein the overseer AGI agent determines a set of autonomous AGI agents within the plurality of autonomous AGI agents connected to the overseer AGI agent which may receive the set of triggers.

4. The system of claim 1, wherein identification of the set of triggers within the backdoor model are identified using a latent space outlier technique.

5. The system of claim 1, wherein identification of the set of triggers within the backdoor model are identified using an input space outlier technique.

6. The system of claim 1, wherein validation of the interaction via the primary model further comprises:
pause the interaction originating from the end-point device; and
transmit a notification to the end-point device.

7. The system of claim 1, wherein the backdoor model receives a refined set of inputs comprised of potential triggers.

8. A computer program product to detect manipulation of training data used for machine learning models, wherein the computer program product comprises at least one non-transitory computer-readable medium having computer-readable program code portions embodied there, the computer-readable program code portions which when executed by a processing device are configured to cause the processor to perform the following operations:
receive an interaction originating from an end-point device;
validate the interaction via a primary model;
identify a set of triggers within a backdoor model,
wherein the backdoor model is modeled off of the primary model capable of undergoing stress testing associated with a set of triggers;
pause the interaction upon identification of the set of triggers within the backdoor model;
transmit the identified set of triggers to an autonomous artificial general intelligence (AGI) agent;
generate a set of synthetic data via the autonomous AGI agent,
wherein the set of synthetic data is training data that removes the set of triggers from the primary model; and
distribute the set of synthetic data to the primary model to correct the set of triggers within the primary model.

9. The computer program product of claim 8, wherein the processor further performs the following operations:
transmit the identified set of triggers via the autonomous AGI agent to an overseer AGI agent; and
distribute the set of triggers via the overseer AGI agent to a plurality of autonomous AGI agents connected to the overseer AGI agent,
wherein the plurality of autonomous AGI agents generates a set of synthetic data for a respective primary model to correct the identified set of triggers.

10. The computer program product of claim 9, wherein the overseer AGI agent determines a set of autonomous AGI agents within the plurality of autonomous AGI agents connected to the overseer AGI agent which may receive the set of triggers.

11. The computer program product of claim 8, wherein identification of the set of triggers within the backdoor model are identified using a latent space outlier technique.

12. The computer program product of claim 8, wherein identification of the set of triggers within the backdoor model are identified using an input space outlier technique.

13. The computer program product of claim 8, wherein validation of the interaction via the primary model further comprises:
pause the interaction originating from the end-point device; and
transmit a notification to the end-point device.

14. The computer program product of claim 8, wherein the backdoor model receives a refined set of inputs comprised of potential triggers.

15. A computer-implemented method for detecting manipulation of training data used for machine learning models, the computer-implemented method comprising:
receiving an interaction originating from an end-point device;
validate the interaction via a primary model;
identifying a set of triggers within a backdoor model,
wherein the backdoor model is modeled off of the primary model capable of undergoing stress testing associated with a set of triggers;
pausing the interaction upon identification of the set of triggers within the backdoor model;
transmitting the identified set of triggers to an autonomous artificial general intelligence (AGI) agent;
generating a set of synthetic data via the autonomous AGI agent,
wherein the set of synthetic data is training data that removes the set of triggers from the primary model; and
distributing the set of synthetic data to the primary model to correct the set of triggers within the primary model.

16. The computer-implemented method of claim 15, wherein the computer-implemented method further comprises:
transmitting the identified set of triggers via the autonomous AGI agent to an overseer AGI agent; and
distribute the set of triggers via the overseer AGI agent to a plurality of autonomous AGI agents connected to the overseer AGI agent,
wherein the plurality of autonomous AGI agents generates a set of synthetic data for a respective primary model to correct the identified set of triggers.

17. The computer-implemented method of claim 16, wherein the overseer AGI agent determines a set of autonomous AGI agents within the plurality of autonomous AGI agents connected to the overseer AGI agent which may receive the set of triggers.

18. The computer-implemented method of claim 15, wherein identifying the set of triggers within the backdoor model are identified using a latent space outlier technique.

19. The computer-implemented method of claim 15, wherein identifying the set of triggers within the backdoor model are identified using an input space outlier technique.

20. The computer-implemented method of claim 15, wherein validating the interaction via the primary model further comprises:
pausing the interaction originating from the end-point device; and
transmitting a notification to the end-point device.
